(19) United States
(12) Patent Application Publication
(10) Pub. No.: US 2019/0270142 A1
(43) Pub. Date: Sep. 5, 2019

(54) COMPOSITE TOOL HOLDERS AND APPLICATIONS THEREOF

(71) Applicant: Kennametal Inc., Latrobe, PA (US)

(72) Inventor: Alan J. Bookheimer, Greensburg, PA (US)

(21) Appl. No.: 15/910,674

(22) Filed: Mar. 2, 2018

(51) Int. Cl. B23B 31/00; B23B 51/02

(52) U.S. Cl. CPC B23B 31/005; B23B 51/02; B23B 2222/92; B23B 2222/84; B23B 2222/28; B23B 2260/138

(57) ABSTRACT

In one aspect, composite tool holders are described herein comprising advantageous structural arrangements of metal carbide and alloy components. Briefly, a composite tool holder comprises a metal carbide shank comprising a bore having an inner diameter and outer diameter. An alloy sleeve is positioned in the bore for engaging a tool, wherein the alloy sleeve is bonded to inner diameter surfaces of the bore via a crosslinked adhesive.

### FIELD

The present invention relates to tool holders and, in particular, to tool holders comprising carbide and alloy components.

### BACKGROUND

Tool holder assemblies configured for use with interchangeable cutting or machining tools provide a number of process efficiencies. A smaller number of machine spindles, for example, can be employed for a larger variety of machining operations, and downtime between various cutting tasks can be reduced by decreased need to switch apparatus for each machining application. In order to realize the foregoing efficiencies, tool coupling systems must provide secure connection with minimal tool change downtime while maintaining desired operating tolerances.

Metal carbide compositions offer high hardness, rigidity and wear resistance. Accordingly, metal carbide compositions are often employed in tooling applications as cutting elements or claddings. Metal carbides can also be employed in tool holder assemblies. However, differences in coefficients of thermal expansion (CTE) between metal carbides and various alloys, including steel, have limited design options for incorporating carbide components into tool holders and associated assemblies. Carbide components, for example, often share limited interfaces with steel components to minimize CTE induced stresses, which can lead to carbide cracking and component failure. Minimization of carbide-alloy interfaces restricts the ability of tool holders to fully realize material advantages of carbides, such as high rigidity and good thermal conductivity.

### SUMMARY

In one aspect, composite tool holders are described herein comprising advantageous structural arrangements of carbide and alloy components. Briefly, a composite tool holder comprises a carbide shank comprising a bore having an inner diameter and outer diameter. An alloy sleeve is positioned in the bore for engaging a tool, wherein the alloy sleeve is bonded to inner diameter surfaces of the bore via a crosslinked adhesive. In some embodiments, the inner diameter of the bore varies along the longitudinal axis of the shank Difference between the inner diameter and outer diameter corresponds to thickness of the carbide wall(s) defining the bore. As described further herein, the shank can also be formed of ceramic or tungsten heavy alloy as opposed to carbide.

In another aspect, methods of making composite tool holders are described. A method of making a composite tool holder comprises providing a shank comprising a bore having an inner diameter and outer diameter, positioning an alloy sleeve in the bore for engaging a tool and bonding the alloy sleeve to inner diameter surfaces of the bore via a crosslinked adhesive, wherein the shank is formed of carbide, ceramic or tungsten heavy alloy. In some embodiments, the adhesive is cured or crosslinked at room temperature. Alternatively, the adhesive can be cured at elevated temperatures.

In a further aspect, tooling assemblies are described. A tooling assembly comprises a composite tool holder including a metal carbide shank comprising a bore having an inner diameter and outer diameter and an alloy sleeve positioned in the bore for engaging a tool. The alloy sleeve is bonded to inner diameter surfaces of the bore via a crosslinked adhesive, and a tool is coupled to the alloy sleeve. In some embodiments, the tool is a rotary cutting tool, including drills or endmills of various design.

These and other embodiments are further described in the following detailed description.

### BRIEF DESCRIPTION OF THE DRAWINGS

FIG. 1 is a cross-sectional schematic of a composite tool holder according to some embodiments.

FIG. 2 is a cross-sectional schematic of a tooling assembly according to some embodiments.

FIG. 3 is an exploded view of a tooling assembly according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Composite Tool Holders

A composite tool holder described herein comprises a shank comprising a bore having an inner diameter and outer diameter, the shank formed of carbide, ceramic or tungsten heavy alloy. An alloy sleeve is positioned in the bore for engaging a tool, wherein the alloy sleeve is bonded to inner diameter surfaces of the bore via a crosslinked adhesive. In some embodiments, the inner diameter of the bore varies along the longitudinal axis of the carbide shank. For example, the inner diameter of the bore can decrease in a direction proceeding away from the bore opening. In such an embodiment, walls of the bore are thicker at the base of the bore in comparison to the walls proximate the bore opening. In some embodiments, the bore has a conical profile for receiving the alloy sleeve. Alternatively, the inner diameter can remain constant along the longitudinal axis of the carbide shank. A constant inner diameter can present a cylindrical bore for receiving the alloy sleeve, in some embodiments.

Turning now to specific components, the shank can comprise carbide, ceramic or tungsten heavy alloy. In some embodiments, for example, the shank can be formed of any metal carbide not inconsistent with the objectives of the present invention. In some embodiments, the metal carbide shank comprises sintered cemented carbide. Sintered cemented carbide of the shank can comprise tungsten carbide (WC). WC can be present in the sintered carbide in an amount of at least 70 weight percent or in an amount of at least 80 weight percent. Additionally, metallic binder of sintered carbide can comprise cobalt or cobalt alloy. Cobalt, for example, can be present in the sintered cemented carbide in an amount ranging from 0.5 weight percent to 30 weight percent. In some embodiments, cobalt is present in sintered cemented carbide of the shank in an amount ranging from 0.5-5 weight percent or from 5-12 weight percent. Sintered cemented carbide of the shank can also comprise one or more additives such as, for example, one or more of the following elements and/or their compounds: titanium, niobium, vanadium, tantalum, chromium, zirconium and/or hafnium. In some embodiments, titanium, niobium, vanadium, tantalum, chromium, zirconium and/or hafnium form solid solution carbides with WC of the sintered cemented carbide. In such embodiments, the sintered carbide can comprise one or more solid solution carbides in an amount ranging from 0.1-5 weight percent.

In some embodiments, a single grade of sintered cemented carbide can be employed in the shank. In other embodiments, sintered cemented carbide of the shank can exhibit one or more compositional gradients. Sintered cemented carbide forming the bore walls can have composition differing from remaining regions of the carbide shank. For example, sintered cemented carbide of the bore walls may comprise small average grain size and lower metallic binder content for enhancing hardness and rigidity. Progressing away from the bore along the longitudinal axis of the shank, the sintered cemented carbide may transition to increased grain size and/or binder content to enhance toughness and fracture resistance.

Alternatively, the shank can comprise or be formed of one or more ceramics. Suitable ceramic materials for shank fabrication include, but are not limited to, SiAlON, silicon carbide, silicon nitride, whisker reinforced ceramics, or alumina carbides. In further embodiments, the shank can comprise or be formed of tungsten heavy alloy. Tungsten particle content can be varied, but is generally present in an amount greater than 90 wt. % of the alloy. Matrix or binder phase of the tungsten heavy alloy can comprise Ni—Fe alloy or Ni—Cu alloy.

As described herein, an alloy sleeve is positioned in the bore for engaging a tool. The alloy sleeve can comprise one or more coupling structures or features for engaging the tool. For example, the sleeve can comprise threads, slots, flanges, tapered surface(s) or any combination thereof for coupling with a tool inserted into the sleeve. Tool coupling structures can generally reside on inner diameter surfaces of the alloy sleeve. However, coupling structures may also be present on one or more exterior surfaces of the alloy sleeve. In some embodiments, coupling structures or features are formed directly on and/or in surfaces of the alloy sleeve. For example, threads or slots can be machined on inner diameter surfaces of the alloy sleeve. When formed on or in surfaces of the alloy sleeve, the coupling structures or features can taper with the inner diameter. Threads and/or slots can taper with inner diameter surfaces, in some embodiments.

Moreover, the alloy sleeve is bonded to inner diameter surfaces of the bore via a crosslinked adhesive. In some embodiments, the alloy sleeve is bonded over the entire circumference of the bore. In other embodiments, the alloy sleeve can be bonded to more radial sections of the inner diameter surface. Any crosslinked adhesive not inconsistent with the objectives of the present invention can be used. In some embodiments, epoxy adhesive is employed to bond the alloy sleeve to inner diameter surfaces of the bore. Suitable epoxy adhesives can comprise epoxy resins crosslinked with themselves or epoxy resins crosslinked via one or more coreactants. Coreactants for crosslinking in epoxy adhesives can include primary and/or secondary amines. Various amine species for crosslinking, for example, include diethylene triamine, triethylene tetramine, 4,4′-diamino-diphenylmethane and polyaminoamides. Other compounds are also operable to crosslink epoxy resins via the epoxide groups such as polythiols, dicyandiamide, diisocyanates and/or phenolic prepolymers. In some embodiments, the epoxy adhesive comprises one or more diluents, fillers, reinforcement materials and/or toughening agents. Diluents can exhibit reactivity (e.g. mono- and diepoxides) or may be non-reactive (e.g. di-n-butyl phthalate). Toughening agents can comprise low molecular weight polyesters, aliphatic diepoxides or diene-acrylonitrile copolymers with carboxyl end groups for crosslinking participation. In some embodiments, suitable epoxy adhesives for bonding the alloy sleeve to ID surfaces of the bore are available from 3M of St. Paul, Minn. under the SCOTCH-WELD® Epoxies trade designation.

In being positioned in the bore, the alloy sleeve can fit completely within the bore, or a portion of the alloy sleeve is retained in the bore with the remainder of alloy sleeve outside the bore. In some embodiments, for example, the section of alloy sleeve outside the bore comprises a rim for coupling to the end face of the bore. The alloy sleeve can have any desired shape. In some embodiments, the outer wall of the alloy sleeve mirrors shape and dimensions of inner diameter surfaces of the bore. For example, the outer wall of the alloy sleeve can taper in a manner consistent with tapering of the bore inner diameter. The alloy sleeve can be formed of any alloy not inconsistent with the objectives of the present invention. In some embodiments, the alloy sleeve is steel, such as such low-carbon steels, alloy steels, tool steels or stainless steels. In other embodiments, the alloy sleeve is fabricated from cobalt-based alloy, nickel-based alloy or various iron-based alloys.

Positioning the alloy sleeve in the bore of the shank provides a structural arrangement wherein the carbide, ceramic or tungsten heavy alloy extends a greater distance along the longitudinal axis of the tool holder. This arrangement can enhance performance of the tool holder due to the high rigidity of the carbide, ceramic or tungsten heavy alloy, which provides resistance to torsional and bending forces. In some embodiments, outer diameter surfaces of the bore containing the alloy sleeve are free of cracks. The absence of cracks in the bore walls is a departure from prior brazed architectures where CTE mismatch between steel and carbide components induces carbide cracking and/or other structural defects.

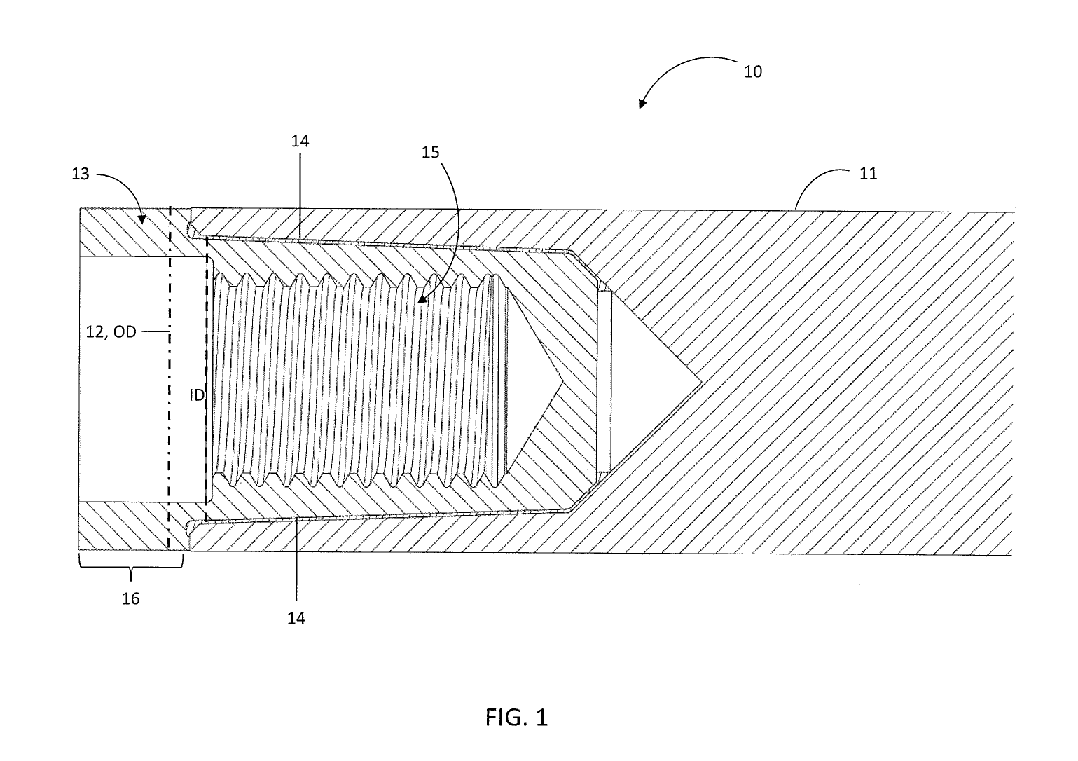

FIG. 1 is a cross-sectional schematic of a composite tool holder according to some embodiments. The tool holder 10 comprises a shank 11 including a bore 12 having an inner diameter (ID) and outer diameter (OD). As described herein, the shank can be formed of metal carbide, ceramic or tungsten heavy alloy. In the embodiment of FIG. 1, the ID decreases or tapers in a direction moving away from the opening of the bore 12. An alloy sleeve 13 for engaging a tool is positioned in the bore 12 and is bonded to ID surfaces of the bore 12 via a crosslinked adhesive 14. The alloy sleeve 13 comprises threads 15 for engaging a tool. As described herein, other tool coupling structures of the alloy sleeve 13 are possible including, but not limited to, slots, flanges and/or tapered surfaces. The outer surface of the alloy sleeve 13 matches the taper of the bore 12. The crosslinked adhesive 14, such as an epoxy adhesive, bonds the outer surface of the alloy sleeve 13 to ID surfaces of the bore 12. In the embodiment of FIG. 1, the alloy sleeve 13 is partially positioned in the bore 12, wherein an annular rim 16 extends outside the bore 13. The rim 16 engages the end surface of the bore 12 and matches the bore OD. In some embodiments, the crosslinked adhesive 14 can be present between rim 16 surfaces and the end face of the bore 12.

In another aspect, methods of making composite tool holders are described. A method of making a composite tool holder comprises providing a shank comprising a bore having an inner diameter and outer diameter, positioning an alloy sleeve in the bore for engaging a tool and bonding the alloy sleeve to inner diameter surfaces of the bore via a crosslinked adhesive, wherein the shank is formed of carbide, ceramic or tungsten heavy alloy. In some embodiments, the adhesive is cured or crosslinked at room temperature. Alternatively, the adhesive can be cured at elevated temperatures. The composite tool holder can have any structure, composition and/or properties described in this Section I.

In some embodiments, inner diameter surfaces of the bore exhibit roughness (Sₐ) of 0.1-1 μm. Roughness (Sₐ) of inner diameter surfaces can also range from 0.3-0.8 μm or 0.4-0.7 m. Roughness of inner diameter surfaces can be influenced by several considerations including, but not limited, to grain size and/or morphology of the metal carbide, ceramic or tungsten heavy alloy forming the bore walls. In some embodiments, inner diameter surfaces are mechanically worked to provide the desired surface roughness. For example, inner diameter surfaces of metal carbide can be blasted with ceramic particles, such as silicon carbide or alumina, to obtain the desired roughness. Additionally, outer diameter surfaces of the alloy sleeve can exhibit surface roughness (Sₐ) of 1-2 μm or 1.3-1.7 μm. Surfaces of the alloy sleeve can be mechanically worked to provide the desired roughness. Mechanical working of alloy sleeve surfaces can include blasting as described herein.

The adhesive is applied to surfaces of the bore and/or alloy sleeve for bonding the alloy sleeve in the bore. The adhesive can be cured or crosslinked at room temperature or elevated temperatures. In some embodiments, for example, the adhesive is cured at a temperature of 20-25° C. Curing can also occur at temperatures less than 20° C. or greater than 25° C. Elevated curing temperatures inducing high tensile stress and/or cracks in the shank due to CTE mismatch with the alloy sleeve are generally avoided. Curing or crosslinking temperature of the adhesive can be selected according to several considerations including, but not limited to, compositional parameters of the adhesive and compositional parameters of the metal carbide and alloy sleeve.

### II. Tooling Assemblies

In a further aspect, tooling assemblies are described. A tooling assembly comprises a composite tool holder including a shank comprising a bore having an inner diameter and outer diameter and an alloy sleeve positioned in the bore for engaging a tool As described in Section I herein, the shank can be formed of carbide, ceramic or tungsten heavy alloy. The alloy sleeve is bonded to inner diameter surfaces of the bore via a crosslinked adhesive, and the tool is coupled to the alloy sleeve. The composite tool holder can have any design, structure and/or compositional properties described in Section I above. Moreover, the tool, in some embodiments, is a cutting tool. Cutting tools can include rotary cutting tools such as a variety of endmills or drills. In other embodiments, the tool is not a cutting tool. The tool, for example, can be an extender or connector of the tooling assembly.

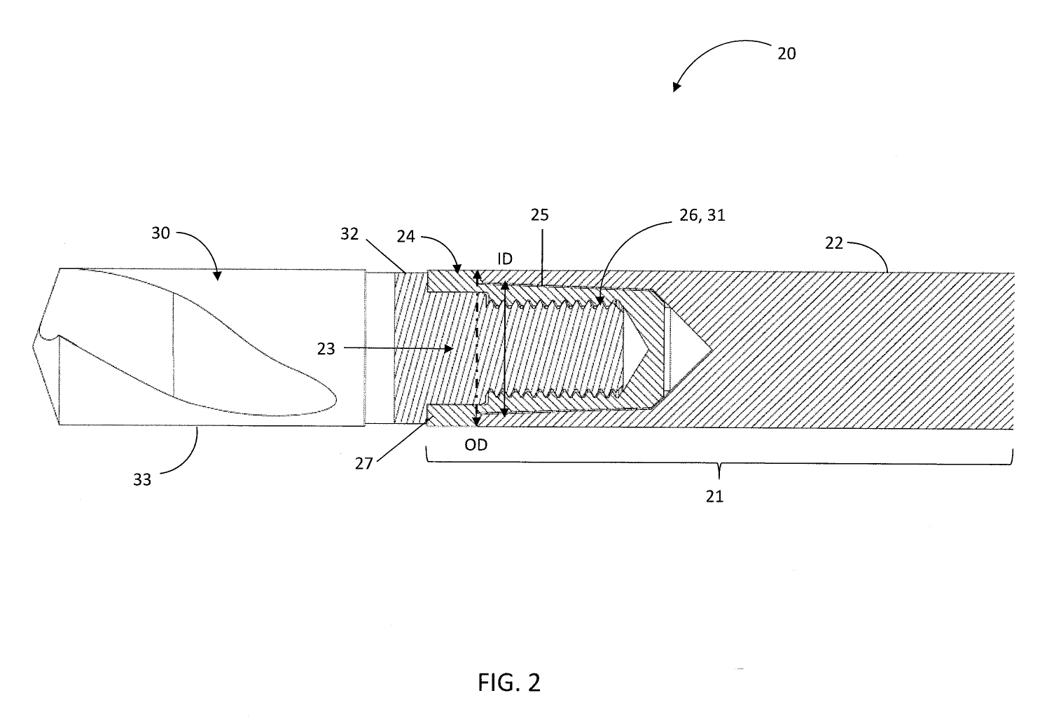

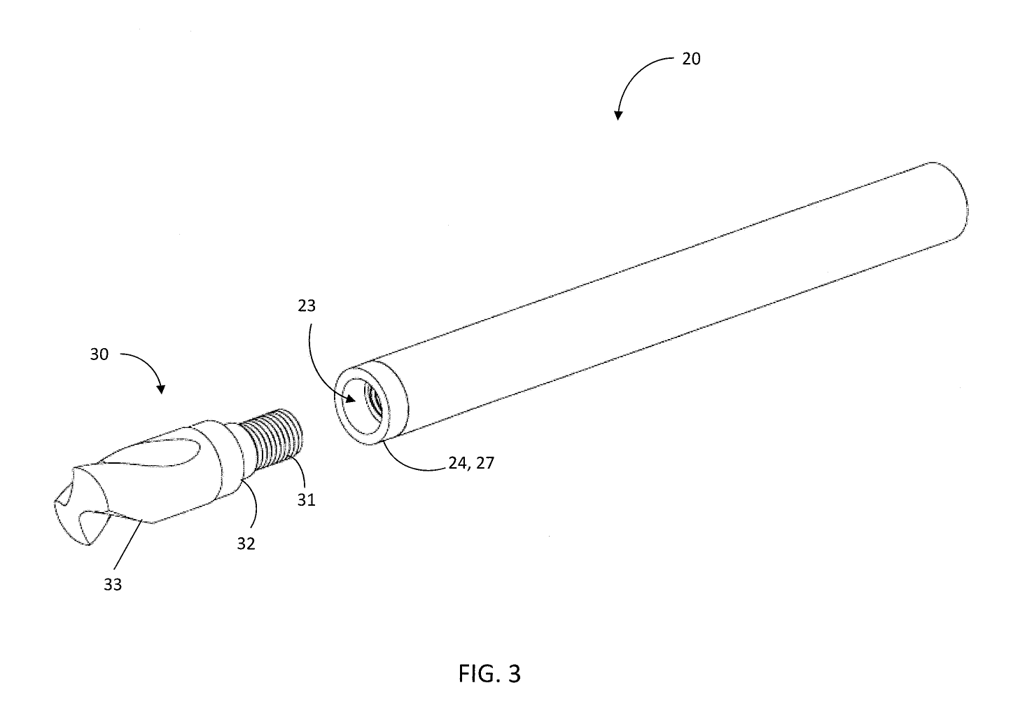

FIG. 2 is a cross-sectional schematic of a tooling assembly according to some embodiments. The tooling assembly 20 comprises a composite tool holder 21 and a rotary cutting tool 30 coupled to the composite tool holder 21. The composite tool holder 21 has a construction as described in FIG. 1. The tool holder 21 comprises a shank 22 including a bore 23 having an inner diameter (ID) and outer diameter (OD). An alloy sleeve 24 engaging the rotary cutting tool 30 is positioned in the bore 23 and is bonded to ID surfaces of the bore 23 via a crosslinked adhesive 25. The alloy sleeve 24 employs threads 26 for engaging threads 31 of the rotary cutting tool 30. The annular rim 27 of the alloy sleeve 24 engages a section 32 of the cutting tool 30 residing between the threads 31 and working portion 33. In some embodiments, the annular rim 27 can act as a stop for the rotary cutting tool 30. FIG. 3 is an exploded view of a tooling assembly of FIG. 2. The carbide shank 22 can be coupled to a spindle or other rotational apparatus.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composite tool holder comprising:
a shank comprising a bore having an inner diameter and outer diameter, the shank being formed of carbide, ceramic or tungsten heavy alloy; and
an alloy sleeve positioned in the bore for engaging a tool, wherein the alloy sleeve is bonded to inner diameter surfaces of the bore via crosslinked adhesive.

2. The composite tool holder of claim 1, wherein the alloy sleeve is steel.

3. The composite tool holder of claim 1, wherein the inner diameter of the bore varies along a longitudinal axis of the shank.

4. The composite tool holder of claim 1, wherein outer diameter surfaces of the bore are free of cracks.

5. The composite tool holder of claim 1, wherein the shank is formed of the carbide, the carbide comprising tungsten carbide.

6. The composite tool holder of claim 1, wherein the shank is formed of the carbide, the carbide comprising sintered cemented carbide.

7. The composite tool holder of claim 1, wherein the crosslinked adhesive comprises epoxy adhesive.

8. The composite tool holder of claim 1, wherein the alloy sleeve comprises one or more coupling structures for engaging the tool.

9. The composite tool holder of claim 1, wherein a portion of the alloy sleeve extends outside the bore.

10. A tooling assembly comprising:
a composite tool holder comprising a shank comprising a bore having an inner diameter and outer diameter and an alloy sleeve positioned in the bore for engaging a tool, wherein the shank is formed of carbide, ceramic or tungsten heavy alloy, and the alloy sleeve is bonded to inner diameter surfaces of the bore via crosslinked adhesive; and
a tool coupled to the alloy sleeve.

11. The tooling assembly of claim 10, wherein the crosslinked adhesive comprises epoxy adhesive.

12. The tooling assembly of claim 10, wherein the tool is a rotary cutting tool.

13. The tooling assembly of claim 10, wherein the inner diameter of the bore varies along a longitudinal axis of the shank.

14. The tooling assembly of claim 10, wherein outer diameter surfaces of the bore are free of cracks.

15. A method of making a composite tool holder comprising:
providing a shank comprising a bore having an inner diameter and outer diameter, the shank formed of carbide, ceramic or tungsten heavy alloy;
positioning an alloy sleeve in the bore for engaging a tool; and
bonding the alloy sleeve to inner diameter surfaces of the bore via crosslinked adhesive.

16. The method of claim 15, wherein the crosslinked adhesive comprises epoxy adhesive cured at a temperature of 20-25° C.

17. The method of claim 15, wherein the inner diameter of the bore varies along a longitudinal axis of the shank.

18. The method of claim 15, wherein outer diameter surfaces of the bore are free of cracks.

19. The method of claim 15, wherein the inner diameter surfaces of the bore have roughness (Sₐ) of 0.1-1 μm.

20. The method of claim 19, wherein outer diameter surfaces of the alloy sleeve have roughness (Sₐ) of 1-2 μm.
